(19) United States
(12) Patent Application Publication
(10) Pub. No.: US 2011/0218886 A1
(43) Pub. Date: Sep. 8, 2011

(54) Parts management system, apparatus, program, method, and storage medium

(75) Inventors: Tsukasa Matsuoka, Kanagawa (JP); Jun Satoh, Kanagawa (JP); Masanori Makino, Kanagawa (JP); Chikara Omata, Tokyo (JP)

(73) Assignee: Ricoh Company, Ltd., Tokyo (JP)

(21) Appl. No.: 13/064,048

(22) Filed: Mar. 3, 2011

(30) Foreign Application Priority Data
Mar. 4, 2010 (JP) 2010-047889

(51) Int. Cl. G06Q 30/00

(52) U.S. Cl. 705/27.1

(57) ABSTRACT

A parts management system includes a catalog data generator to generate catalog data for display of a parts catalog based on image data of a part configuring a machine, and machine configuration information describing a configuration of the machine using identification information for the part configuring the machine; a catalog data storage unit to store the generated catalog data; a display data generator to generate display data displayable on an interface based on the stored catalog data, the display data including the parts catalog and an operating unit for placing an order for the part; and an order information generator to generate order information including the identification information for the part, a quantity of the part, and a delivery destination for the part, in response to inputting an order for the part via the interface.

### CROSS-REFERENCE TO RELATED APPLICATIONS

This application claims priority to Japanese Patent Application No. 2010-047889, filed on Mar. 4, 2010 in the Japan Patent Office, which is incorporated by reference herein in its entirety.

### BACKGROUND OF THE INVENTION

1. Field of the Invention

The present invention relates to a parts management system, a parts management apparatus, a parts management program, and a parts management method, and more particularly, to a system, apparatus, program, and method of managing ordering parts to prevent mistakes and reduce workload.

2. Description of the Background Art

In general, machines such as image forming apparatuses are configured with a large number of component parts. When maintenance staff conduct maintenance work on such machines, they may inspect the machines to check parts that need to be replaced, and procures replacement parts.

For example, JP-2003-16072-A discloses a technology for parts procurement such as ordering parts from suppliers, in which parts location in a machine can be checked using a parts location illustration, and further, by selecting key codes for parts illustrated in the parts location illustration, information on each part, such as a parts code that identifies each part, can be electronically searched and confirmed.

Further, computer aided design (CAD) has come to be widely used in the design of machine products. For example, JP-2007-293437-A discloses a system using CAD for parts procurement, in which, based on shape and position information for each part as well as configuration information on parts stored as CAD data, suitable visual information on parts can be determined, and then such CAD data can be converted to a single part in isolation drawing and a fully assembled drawing to allow accurate checking of the state of the single part in isolation as well as a fully assembled state.

In the method disclosed in JP-2003-16072-A, technical illustrations are used as the illustration data, and as a result the work of preparing a parts catalog for machines having a large number of parts becomes burdensome. By contrast, in the method disclosed in JP-2007-293437-A, CAD data is used to generate illustration data for each part, and the work of preparing parts catalog for machines having a large number of parts can be reduced.

Moreover, when the parts check is completed in the method of JP-2003-16072-A, the order is placed with a specific supplier that can supply specific parts. However, even when the specific parts that need to be procured can be identified, some mistake or error may occur when placing the order for parts. For example, when procuring parts by designating a parts code that identifies each part, a designation of a wrong parts code causes procurement and delivery of the wrong parts. Further, because there are many parts whose shapes and functions are very similar to each other, the wrong parts may be easily procured by mistake.

In addition, machines are configured by combining many parts supplied from many different suppliers, such that some parts are supplied from one supplier, and other parts are supplied from other suppliers. Because parts supplied by different suppliers needs to be ordered to each one of different suppliers separately, a workload of ordering entity becomes heavy.

### SUMMARY

In one aspect of the present invention, a parts management system is devised. The parts management system includes a catalog data generator to generate catalog data for display of a parts catalog based on image data of a part configuring a machine, and machine configuration information describing a configuration of the machine using identification information for the part configuring the machine; a catalog data storage unit to store the generated catalog data; a display data generator to generate display data displayable on an interface based on the stored catalog data, the display data including the parts catalog and an operating unit for placing an order for the part; and an order information generator to generate order information including the identification information for the part, a quantity of the part, and a delivery destination for the part, in response to inputting an order for the part via the interface.

In another aspect of the present invention, a parts management apparatus is devised. The parts management apparatus includes a catalog data generator to generate catalog data for display of a parts catalog based on image data of a part configuring a machine, and machine configuration information describing a configuration of the machine using identification information for the part configuring the machine, the generated catalog data stored in a catalog data storage unit; a display data generator to generate display data displayable on an interface based on the stored catalog data, the display data including the parts catalog and an operating unit for placing an order for the part; and an order information generator to generate order information including the identification information of the part, a quantity of the part, and a delivery destination for the part, in response to inputting an order for the part to the interface.

In another aspect of the present invention, a parts management method is devised. The parts management method includes the steps of: obtaining catalog data for display of a parts catalog, using an information processing apparatus, based on image data of a part configuring a machine and machine configuration information describing a configuration of the machine using identification information for the part configuring the machine; storing the generated catalog data in a catalog data storage unit; generating display data displayable on an interface at the information processing apparatus based on the stored catalog data, the display data including the parts catalog and an operating unit for inputting an order for the part; and generating order information including identification information for the part, a quantity of the part, and a delivery destination for the part, in response to inputting an order for the part to the interface.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows an example environment of operating a parts management system according to an example embodiment;

FIG. 2 shows an example block diagram of a hardware configuration of an information processing apparatus according to an example embodiment;

FIG. 3 shows an overall configuration of the parts management system according to an example embodiment;

FIG. 4 shows an example of machine configuration information according to an example embodiment;

FIG. 5A shows an example of machine configuration information according to an example embodiment;

FIG. 5B shows an example illustration of a part in a machine;

FIG. 6 shows a flowchart of a catalog generation process according to an example embodiment;

FIG. 7 shows an example GUI for a catalog according to an example embodiment;

FIG. 8 shows an example GUI for an ordered parts list according to an example embodiment;

FIG. 9 shows a flowchart of a process of ordering parts using a catalog according to an example embodiment;

FIG. 10 shows an example of order information according to an example embodiment;

FIG. 11 shows an example of parts management information according to an example embodiment;

FIG. 12 shows a flowchart of a process of printing an order sheet using a catalog according to an example embodiment;

FIG. 13 shows example information of a parts list for one machine according to an example embodiment, in which parts having part classification information are listed;

FIG. 14 shows an overall configuration of a parts management system according to another example embodiment; and

FIG. 15 shows an example of information managed by a central server according to another example embodiment.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, a parts management system according to example embodiment is described hereinafter.

In an example embodiment, based on design information of a machine, an electronic catalog for parts can be automatically generated, and based on results of a search of the generated electronic catalog, each part can be ordered to a given destination. Hereinafter, the term “machine” is used to indicate a given object configured with parts. The size and function of the machine is not limited any specific size, and any object such, as a device, machine, or the like configured with parts, may be referred to in this specification as “machine” for simplicity of explanation.

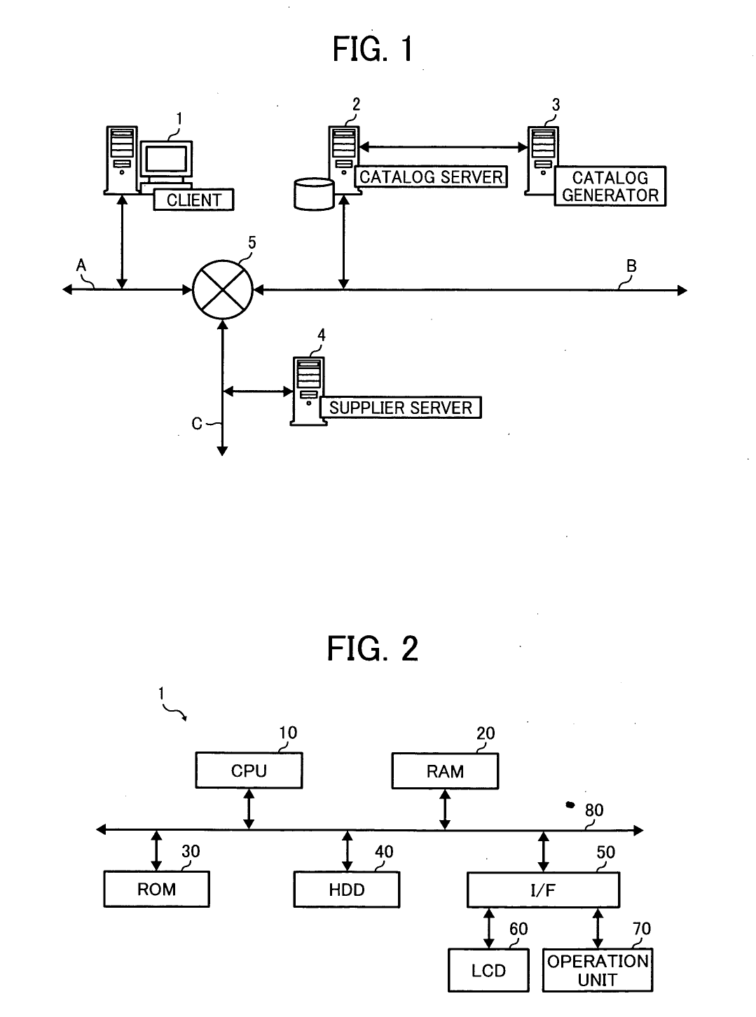

FIG. 1 shows an example environment for operating a parts management system according to the example embodiment. As shown in FIG. 1, the parts management system may include, for example, a network A, a network B, and a network C connected each other via a public line 5 such as the Internet, a phone line, or the like, in which the network A is connected to a client terminal 1, the network B is connected to a catalog server 2, and the network C is connected to a supplier server 4, and further the catalog server 2 may be connected to a catalog generator 3.

The network A may be a network for a service user that uses the parts management system. The network B may be a network providing services of the parts management system. The network C may be a network for a manufacturer or supplier that receives an order of parts via the parts management system. The networks A, B, and C may be connected to the public line 5 via network devices such as rooter.

The client terminal 1 is an information processing apparatus, which may be installed with a viewer to display an electronic catalog provided by the parts management system, and personal computers (PC) or the like may be employed for the information processing apparatus. A user operates the client terminal 1 to activate the viewer to display the electronic catalog provided from the catalog server 2 on the viewer. Further, the user operates the client terminal 1 to search parts using the electronic catalog displayed on the viewer. Furthermore, based on the search result, the user operates the client terminal 1 to generate order information of part that is to be ordered, and transmits the order information to the supplier server 4.

As described above, the catalog server 2 may store information of electronic catalog provided in the parts management system. In response to a request from the client terminal 1, the catalog server 2 transmits information of electronic catalog to the client terminal 1. For example, the catalog generator 3 may generate information of electronic catalog stored in the catalog server 2.

As described above, the catalog generator 3 generates information of electronic catalog for the parts management system. Based on parts configuration information for a machine that needs a generation of electronic catalog and design information for the machine itself such as three-dimensional design information, the catalog generator 3 generates information of an electronic catalog, in which such electronic catalog can be used to visually recognize the shape of each part and the parts location in one machine.

As described above, the supplier server 4 may be a server for a supplier that supplies parts. The order information generated and transmitted by the client terminal 1 is received and stored at the supplier server 4. An operator of the supplier server 4 checks the order information stored in the supplier server 4, and then checks the parts inventory and arranges for parts delivery. The supplier may be a supplier that supplies parts, purchased from other entities, to a customer, or a manufacturer that manufactures parts to be supplied to a customer. For ease of description, the term “supplier” as used herein means any type of supplier that supplies parts to customers.

Further, in FIG. 1, the catalog server 2 and the catalog generator 3 are configured as different servers because the catalog generator 3 may process confidential information of machines such as design information or the like. However, one server can be used for the catalog server 2 and the catalog generator 3.

A description is given of a hardware configuration of the client terminal 1, the catalog server 2, the catalog generator 3, and the supplier server 4 with reference to FIG. 2, which shows an example block diagram of a hardware configuration of the client terminal 1. Although the hardware configuration is described for the client terminal 1, the catalog server 2, the catalog generator 3, and the supplier server 4 can be configured similarly.

As shown in FIG. 2, the image processing apparatus 1 according to the example embodiment may be configured as similar to a general server or PC. Specifically, the image processing apparatus 1 may include a central processing unit (CPU) 10, a random access memory (RAM) 20, a read only memory (ROM) 30, a hard disk drive (HDD) 40, and an interface (I/F) 50, which may be connected each other via a bus 80. Further, the I/F 50 may be connected to a liquid crystal display (LCD) 60 and an operation unit 70.

The CPU 10 is a computing unit, which controls the image processing apparatus 1 as a whole. The RAM 20 is a volatile memory, to which information can be written and read with a high speed, and is used as a working memory when the CPU 10 processes information. The ROM 30 is a non-volatile memory used as a read only memory, and stores programs such as firmware or the like. The HDD 40 is a non-volatile storage, to which information can be written and read, and stores OS (operating system), control programs, application programs, or the like.

The I/F 50 is used to connect various hardware devices and networks to the bus 80, and controls such connection. The LCD 60 is a user interface showing visual information, by which a user can check the status of the image processing apparatus 1. The operation unit 70 is a user interface such as a keyboard, a mouse, by which a user can input information to the image processing apparatus 1. Further, as above described with reference to FIG. 1, the catalog server 2 and the supplier server 4 are used as servers. Accordingly, the catalog server 2 and the supplier server 4 may not be provided with a user interface such as the LCD 60 and operation unit 70. Further, if a direct user operation by a user or operator is not required for the catalog generator 3, the catalog generator 3 may not be provided with a user interface such as the LCD 60 and operation unit 70 as similar to the catalog server 2 and supplier server 4.

In such hardware configuration, programs stored in a storage such as ROM 30, HDD 40, or optical disk can be read and loaded to the RAM 20, and the CPU 10 runs such programs to control units, by which a software-executing controller can be configured. With a combination of such software-executing controller and hardware, functional blocks for operating the client terminal 1, the catalog server 2, the catalog generator 3, and the supplier server 4 can be configured.

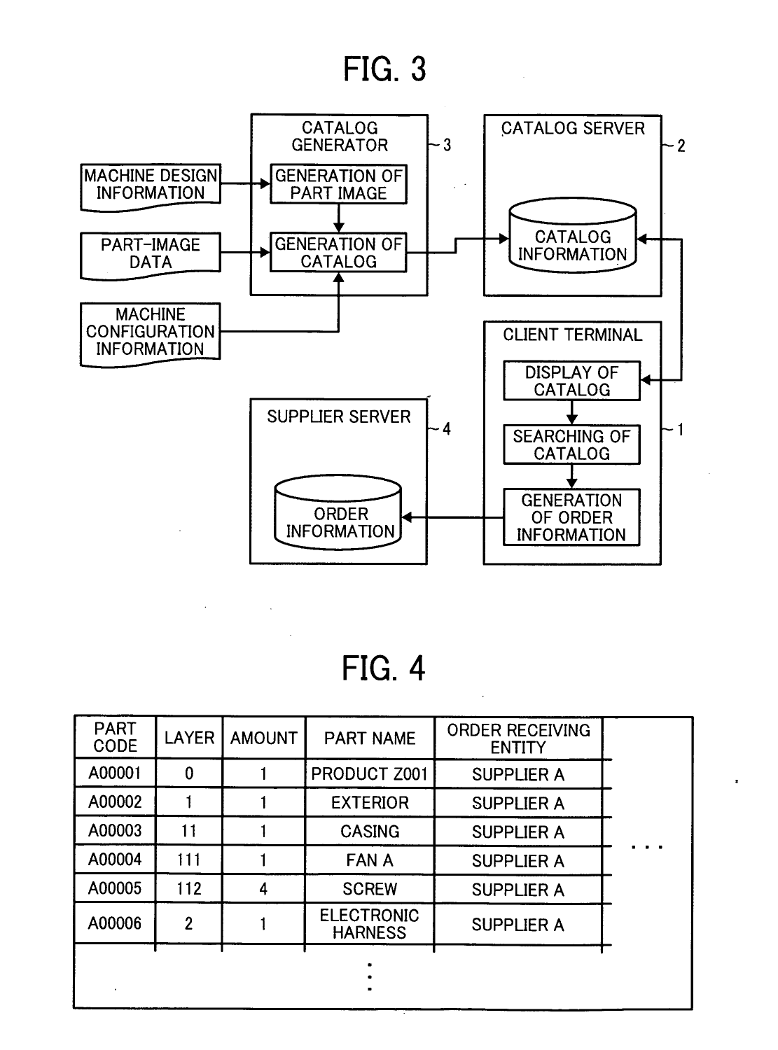

A description is given of an overall configuration of the parts management system with reference to FIG. 3. As shown in FIG. 3, “machine design information”, “part-image information”, and “machine configuration information” may be prepared for embodying the parts management system. Each type of information is described below.

FIG. 4 shows an example information format for machine configuration information. As shown in FIG. 4, the machine configuration information may be configured as a table, in which text information may be layered, and for which, for example, comma-separated values-(CSV-) formatted information may be used. As shown in FIG. 4, the machine configuration information may include information on the parts configuring a given machine, such as parts code, layer information, number of parts or articles, parts name, and order receiving entity.

Parts codes are identification information that identifies each part configuring a given machine. Such parts codes may be information used by suppliers that supply parts, wherein the suppliers may use such parts codes to identify and/or manage parts. In other words, a service provider that provides the parts management system service may not necessarily provide parts codes.

The layer information indicates the layers of information on each part, which are layered in the machine configuration information. For example, the layer “0” indicates a machine itself configured by the machine configuration information. For example, the machine configuration information in FIG. 4 is for a machine called “Product Z001.” The layer number of a single digit other than “0”, such as “1”, “2”, “3”, etc., indicates a sub-unit of one machine divided. In the case of Product Z001 in FIG. 4, Product Z001 includes the sub-units “exterior” and “electronic harness.” In other words, a single-digit layer number indicates a group composed of a plurality of parts, and the group is a major component of a single machine when that single machine is divided.

Further, as parts become smaller and smaller, the layer number becomes greater (e.g., the layer number becomes two digits, three digits, etc.). When a unit having the layer number “1” includes one part, the layer number of one part may be defined as “1*” such as “11,” “12,” and so on. Furthermore, as shown in FIG. 4, a part included in the casing (layer number of 11) has the layer number of “11*” such as “111,” “112,” and so on. In the example shown in FIG. 4, the fan A and screw are the smallest discrete parts for the Product Z001.

The number of parts or articles indicates how many of one part are included in a single unit. For example, one fan A (layer number 111) and four screws (layer number 112) are included in the casing (layer number 11).

The parts name indicates the name of each part. Further, depending on the layer number of parts, the parts name indicates a name of a unit or sub-unit, a name of group of parts, or a name of the machine itself.

The order receiving entity indicates a destination of order information when an order for each part is placed. In the example embodiment, the order receiving entity is identified by a name of a supplier that supplies parts (e.g., supplier A), but other destination information such as a network address or a mail address can be used. As such, the machine configuration information is information in which the configuration of the concerned machine is described by the parts codes of the parts that constitute the machine.

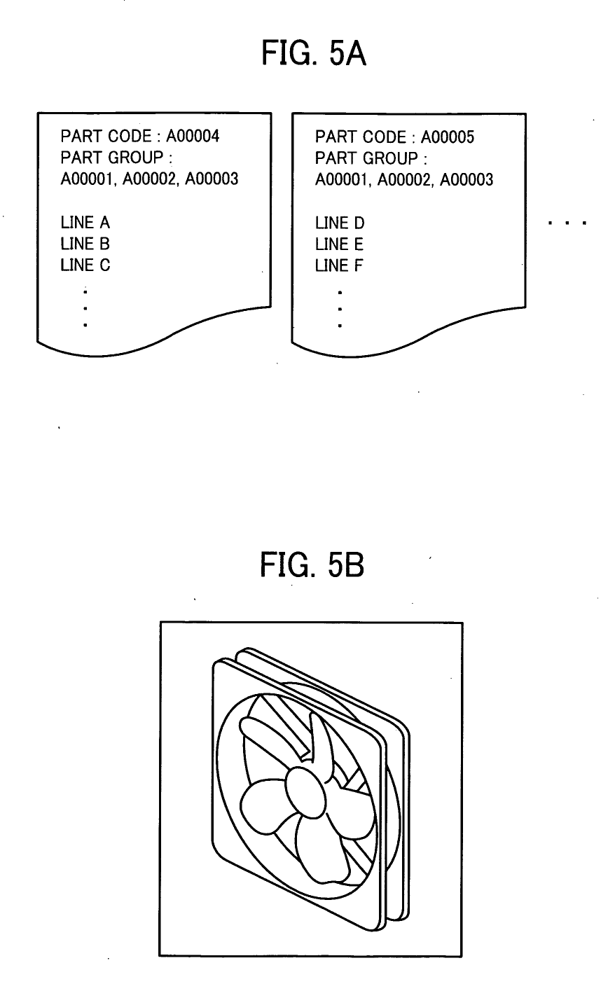

The “machine design information” is drawing information to draw images of a three-dimensional configuration of a concerned machine, for which CAD information is generally used. FIG. 5A shows example information included in the machine design information. In the machine design information, information to draw images of each part configuring one machine may be a set of line information for configuring a given three-dimensional space. Accordingly, the machine design information may include a set of line information configuring a given three-dimensional space. For example, line information such as line A, line B in FIG. 5A are lines identified by coordinates in a three-dimensional system. Such line information may be used as shape information of parts configuring one machine, and the shape information of parts may indicate a three-dimensional shape of the part. As such, the machine design information may include shape information of parts indicating three-dimensional shape of the parts.

Further, line information as shown in FIG. 5A, such as a plurality of lines configuring the machine design information, may be grouped for each part that is drawn as one image by the plurality of lines. For example, the image of fan A having the parts code A00004 can be drawn using lines A, B, C, and so on. Furthermore, the parts code included in the machine configuration information may be used as attribute information for each part to be drawn as an image.

Furthermore, the line information for each part may be corresponded to the layer information (see FIG. 4), by which a relation of a part belonging to a unit can be indicated as “part group” as shown in FIG. 5A. For example, the line information of fan A (lines A, B, C, . . . ) having the parts code A00004 may belong to Product Z001 having the parts code A00001, exterior having the parts code A00002, and casing having the parts code A00003 as shown in FIG. 5A. Hereinafter, a group of lines for drawing each part may be referred to as part-drawing line information.

The machine design information may include the shape information of the part by associating with the identification information of the part. Further, when a plurality of same parts is used in one machine, each of the same parts has a same identification information of identifying the part (such as parts code) and may also have specific-position information of identifying a position of the each of the same parts because the position of the each of the same parts are different each other.

Based on the machine design information of FIG. 5A, a part can be drawn as a three-dimensional drawing as shown in FIG. 5B. FIG. 5B shows one example of three-dimensional drawing of one part using lines included in the part-drawing line information.

When the above-described machine design information is not available for use, the part-image information may be prepared as parts image data or information. For example, photo information of parts captured by a digital camera, or illustration information of parts illustrated by a user or operator, may be used to prepare images of parts as the part-image information. Similar to the above-described part-drawing line information, the parts code included in the machine configuration information may be set as attribution information for the part-image information.

Based on the above-described three types of information, the catalog generator 3 may generate catalog data or information. Specifically, the CPU 10 that conducts processing using a program loaded on the RAM 20 in the catalog generator 3 may function as a catalog data generator. As shown in FIG. 3, the catalog generator 3 may generate image of parts based on the machine design information. Then, the catalog generator 3 may generate catalog information based on the generated image of parts and the machine configuration information, in which instead of the generated image of parts, the above descried part-image information may be used in some cases.

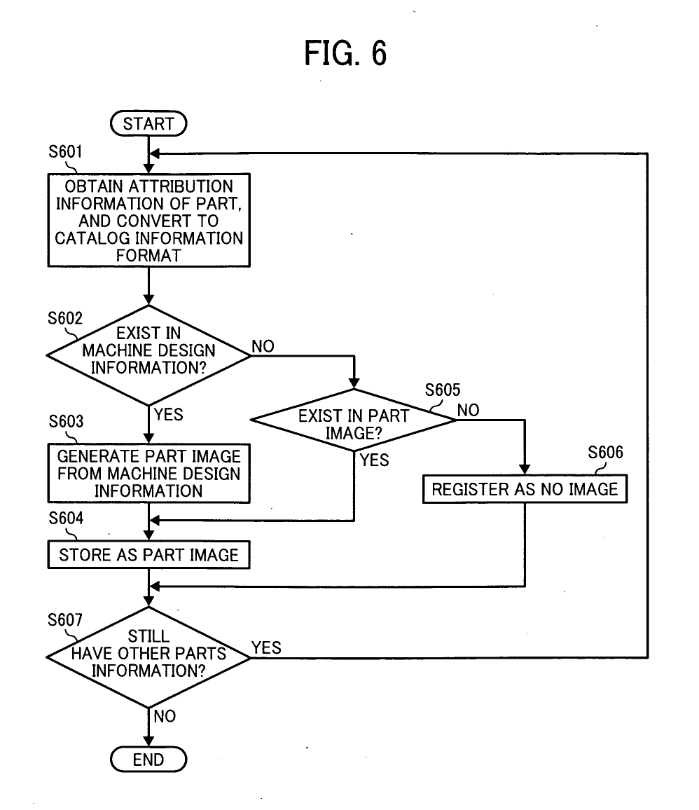

A description is now given of a process of generating a catalog with the catalog generator 3 with reference to FIG. 6. As shown in FIG. 6, at first, the catalog generator 3 obtains attribution information on parts from the machine configuration information, and converts the information to catalog information format (step S601). The attribution information may be each piece of information described with reference to FIG. 4.

Based on the parts code obtained at step S601, the catalog generator 3 searches attribution information of part-drawing line information included in the machine design information, and determines whether a parts code corresponding to the attribution information exists (step S602). If the corresponding parts code exists (step S602: YES), based on the part-image drawing information having the corresponding parts code as attribution information, the catalog generator 3 generates two-dimensional or three-dimensional image data of the part (step S603). Specifically, the CPU 10 that conducts processing using a program loaded in the RAM 20 in the catalog generator 3 functions as an image data generator.

When the two-dimensional or three-dimensional image data is generated at step S603, the catalog generator 3 associates the generated image data with the attribution information obtained at step S601, and stores the data (step S604).

By contrast, if the corresponding parts code does not exist (step S602: NO) based on the determination result of step S602, the catalog generator 3 similarly searches attribution information in the part-image information to determine whether the corresponding parts code exists (step S605). If the corresponding parts code exists in the part-image information (step S605: YES), the catalog generator 3 associates image data of the part with the attribution information obtained at step S601, and stores the data (step S604). As above described, the machine design information may include the shape information of the part by associating with the identification information of the part, by which the image data generator may generate the image data of the part by associating with the shape information of the part. Further, the machine design information may include the specific-position information different for each of the same parts, by which the image data generator may generate the image data of each of the same parts using the same identification information of the same parts, the shape information of the same parts, and the specific-position information different for each of the same parts.

By contrast, if the corresponding parts code does not exist (step S605: NO) in the part-image information based on the determination result of step S605, the image data of the part, corresponding to the parts code obtained at step S601, is registered as “none” (step S606).

When step S604 or step S606 is completed, the catalog generator 3 checks the machine configuration information again to determine whether information on parts not obtained yet still exists (step S607). If no other parts information exists based on the determination result at step S607 (step S607: No), the catalog generator 3 ends the process. By contrast, if other parts information exists based on the determination result at step S607 (step S607: Yes), the catalog generator 3 repeats the process from step S601. With such processing, the process of generating catalog data with the catalog generator 3 ends.

As shown in FIG. 3, catalog data generated by the catalog generator 3 may be stored in a storage such as HDD 40 disposed in the catalog server 2, in which the HDD 40 may function as a catalog data storage or storage unit. When the client terminal 1 activates the viewer in response to a user's operation, the client terminal 1 obtains the catalog data from the catalog server 2 via the network to display the catalog data on the viewer. Specifically, the CPU 10 that conducts processing using a viewer program loaded on the RAM 20 in the catalog generator 3 may function as a catalog data obtaining unit and a display data generator.

Further, as shown in FIG. 3, the client terminal 1 generates order information based on the display of catalog, the searching of catalog, and the search result of catalog. In other words, the catalog data includes parts list information including the above described attribution information and image data of parts, and may further include a program to provide functions of display of catalog, searching of catalog, and ordering of parts.

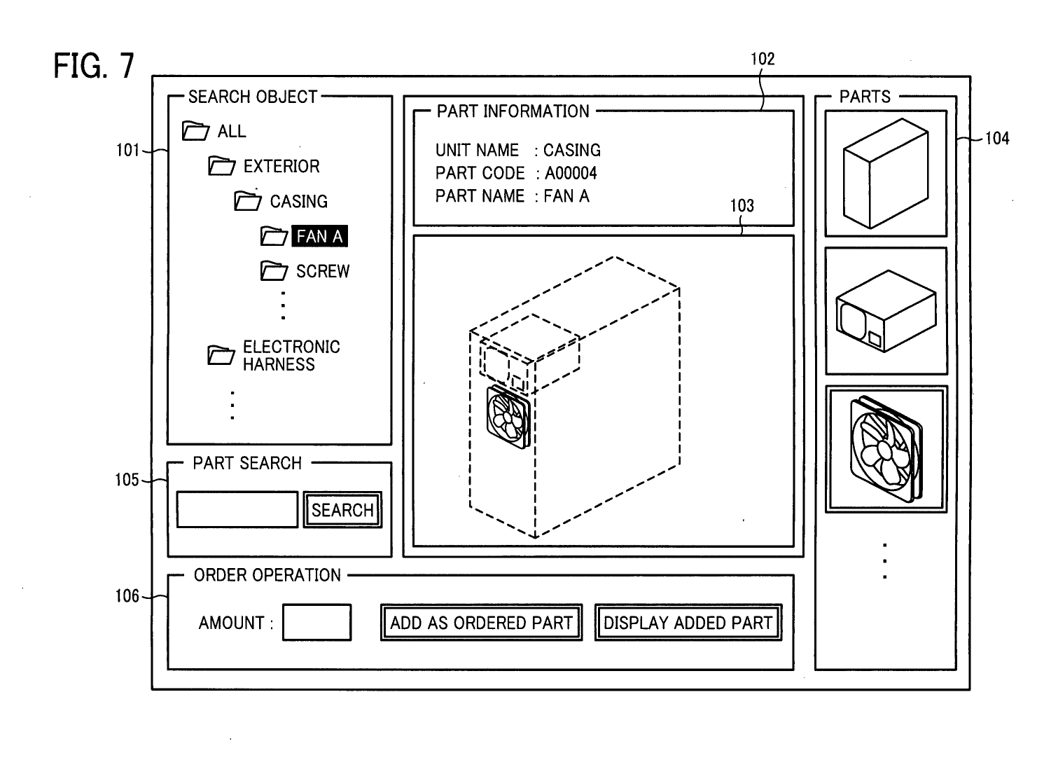

A description is given of display style of catalog at the client terminal 1 with reference to FIG. 7, which shows an example graphical user interface (GUI) used for the parts catalog displayed on the viewer of the client terminal 1 in the parts management system. As shown in FIG. 7, the GUI of parts catalog may include a parts-tree display window 101, a part information display window 102, a unit image display window 103, a parts list display window 104, a part search window 105, and an order operation window 106.

The parts-tree display window 101 may display a configuration of parts included in the concerned machine with a tree style based on the layer information shown in FIG. 4. Further, in the parts-tree display window 101, the selected part or unit may be displayed with an inverted manner. As such, in the example embodiment, because each unit and part may be displayed with the tree style in an electronic catalog based on parts configuration of each machine, a user can recognize and obtain a concerned part easily.

The part information display window 102 may display attribution information for parts in the process of being selected. As shown in FIG. 7, a unit name of a unit configured with a part in the process of being selected, and parts code and parts name of the part in the process of being selected, may be displayed in the parts information display window 102.

The unit image display window 103 may display the image of a selected part and unit including the selected part selected at the parts-tree display window 101. In the unit image display window 103, as shown in FIG. 7, the outer periphery of the unit configured with the selected part may be displayed using broken lines, and the selected part configuring the unit may be displayed using solid lines, by which the selected part in the unit can be recognized or identified easily, and the location of selected part in the unit can be recognized or identified easily. Further, if the GUI can support a multi-color display, the selected part and the unit can identified using different colors instead of solid/broken lines to identify the part.

The parts list display window 104 may display image list of selected part configuring one unit. As shown in FIG. 7, the selected part may be displayed with a given manner in the parts list display window 104 such as high-lighted manner, but not limited thereto. A user can select a part using a pointing device such as a mouse provided for the client terminal 1, in which the user can select a part by clicking, for example, information in the parts-tree display window 101 or the parts list display window 104.

The part search window 105 is a GUI used for searching a part in catalog by a user. The part search window 105 may include an input section to input information such as text, character, or the like, and a search button to instruct an execution of searching. When the user inputs a concerned part name in the input section of the part search window 105 and clicks the search button, information in the parts catalog is searched and then a search result may be displayed on a GUI.

The order operation window 106 is a GUI used for placing a parts order for the selected part selected in the catalog, which may be operated by a user. The order operation window 106 includes an input section to input the order amount of selected part, an “add as ordered part” button to instruct to add the selected part as an ordered part, and a “display added part” button to instruct to display the added part as the ordered part. As such, the order operation window 106 may be used as an operating unit.

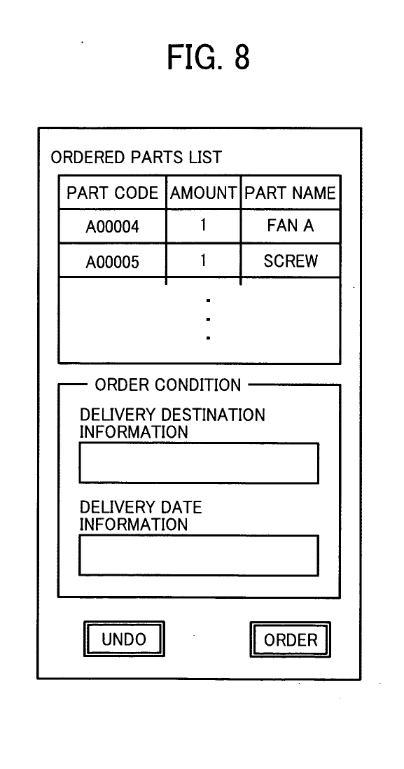

When the user inputs the order amount of part in the input section of the order operation window 106 and clicks the “add as ordered part” button, the order quantity or amount of selected part is temporarily stored as the ordered part. Then, the user clicks the “display added part” button of the order operation window 106 to display the ordered part, temporarily stored, as a part list as shown in FIG. 8 which may be referred to as ordered parts list.

As shown in FIG. 8, the ordered parts list may display a list of parts added by a user operation as the ordered part with information, for example, parts code, order quantity or amount, and part name. Furthermore, the GUI of ordered parts list may include a “undo” button and an “order” button, in which the undo button is used to display an interface (such as screen image) of the parts catalog of FIG. 7 again, and the order button is used to instruct an ordering of the ordered part. When the user clicks the order button, a function provided by the parts catalog may generate order information for the part, temporarily stored as the ordered part, and transmits the order information to the supplier server 4.

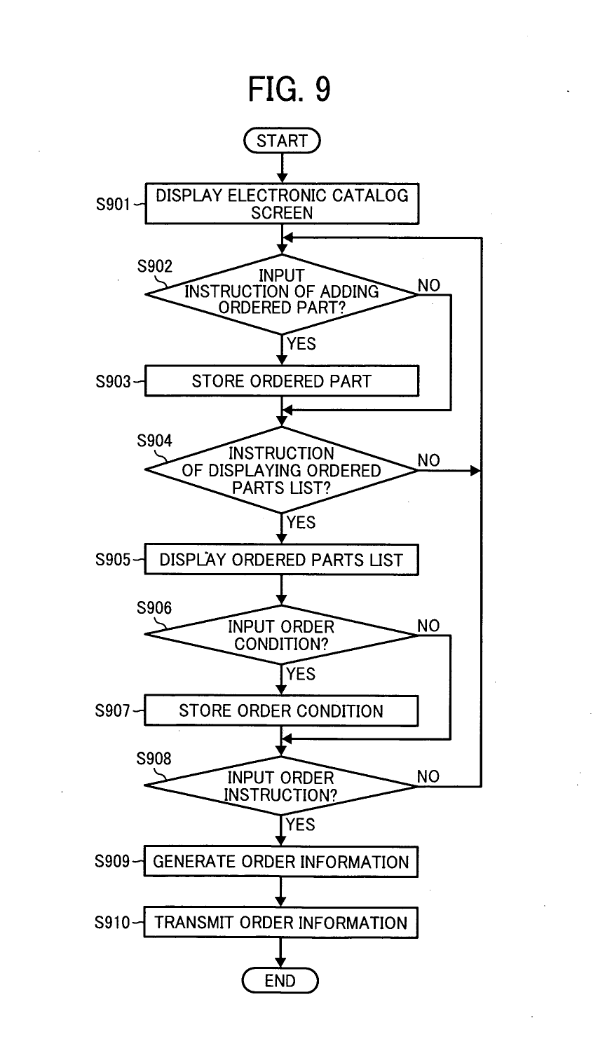

A description is given of an ordering process of parts using parts catalog with reference to FIG. 9, which shows a flowchart of process for ordering parts using a parts catalog according to an example embodiment. As shown in FIG. 9, an electronic catalog screen shown in FIG. 7 is displayed at the client terminal 1 (step S901). When a user inputs an instruction of adding an ordered part (step S902: YES), the client terminal 1 temporarily stores the ordered part (step S903).

When the user inputs a display instruction of the ordered parts list (step S904: YES), the client terminal 1 displays the ordered parts list shown in FIG. 8 (step S905). When the user inputs an order condition from the ordered parts list displayed at the client terminal 1 (step S906: YES), the client terminal 1 stores the input order condition (step S907).

When the user clicks the order button on the ordered parts list to instruct an order of part (step S908: YES), the client terminal 1 generates order information based on the stored ordered part and order condition (step S909). Specifically, the CPU 10 that conducts processing using a program in the catalog data loaded on the RAM 20 in the catalog generator 3 may function as an order information generator. Further, the client terminal 1 may generate the order information by associating with information of the order receiving entity (see FIG. 4) when generating the order information. Further, the client terminal 1 generates the order information for each order receiving entity when information of order receiving entity (see FIG. 4) includes a plurality of entities.

When the order information is generated, the client terminal 1 transmits the order information to the supplier server 4 (step S910). Specifically, the CPU 10 that conducts processing using a program in the catalog data loaded on the RAM 20 in the catalog generator 3 may function as an order information transmitting unit. Then, the client terminal 1 stores the transmitted order information as the order record. With such processing, the ordering process of parts using the electronic catalog ends. Further, at step S910, the client terminal 1 identifies a transmission destination (i.e., supplier server), to which the order information is transmitted, based on information of the order receiving entity associated with each order information. Further, when a plurality of parts is designated as the ordered part to different order receiving entities, order information is transmitted to each of order receiving entities such as suppliers separately.

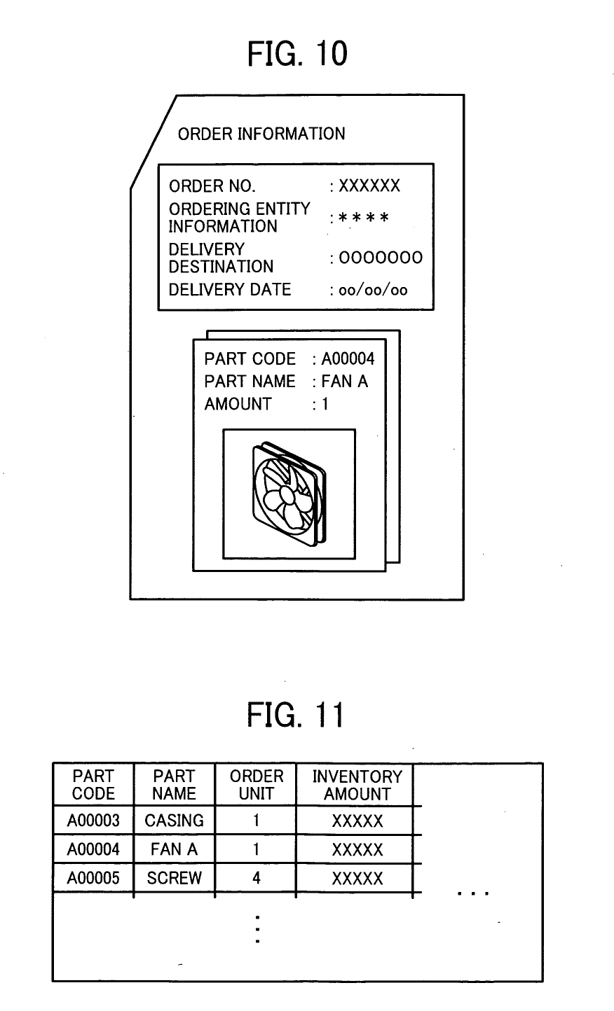

FIG. 10 shows an example of order information generated at step S909 by the client terminal 1. As shown in FIG. 10, the order information may include main information and part-specific information for the each ordered part. The main information may include order number, ordering entity information, delivery destination and delivery date, and the part-specific information may include parts code, part name, order amount of part, and image data of part.

Such order information is transmitted to the supplier server 4, and stored in a storage such as HDD 40 in the supplier server 4, which may be used as a received-order information storage or storage unit. Then, an operator of the supplier server 4 can confirm the receiving of part order. Then, the inventory check of part and delivery of part may be conducted at a supplier that supplies parts. As described with FIG. 4, the parts code included in the order information is information used by each of suppliers to identify and manage parts in each of suppliers that supply parts. Accordingly, at the suppliers, an existing order receiving system can be linked to the received order information easily.

In the above-described parts management system, parts management may be conducted consistently using parts codes set by suppliers from generation of an electronic catalog and searching of parts in the electronic catalog to transmission of order information. In such system, human error, such as inputting the wrong parts code for a part that needs to be ordered, can be prevented. Further, because the order information can be generated based on the results of a search of the electronic catalog, the workload of the ordering entity can be reduced.

Furthermore, in the above described parts management system, the order information can be generated using a given format set in advance as shown in FIG. 10. Because suppliers receiving a part order can process an order-receiving processing using the format set in advance for the order information, a workload at suppliers, which is involved in the above described parts management system, can be reduced. Furthermore, as shown in FIG. 10, because image of part can be included in the order information, suppliers receiving the part order can confirm the part for procurement from the parts code and also the image of part, by which a delivery of wrong part can be effectively prevented furthermore.

Further, in the above-described example embodiment, the client terminal 1 conducts searching of catalog, generation of order information, and transmission of order information in response to a user operation. Furthermore, the client terminal 1 can obtain information of the order unit of part and information of inventory of part from the supplier server 4, which is described as follows.

FIG. 11 shows an example of part management information stored in the supplier server 4. As shown in FIG. 11, the part management information stored in the supplier server 4 may include parts code, part name, order unit and inventory amount. The information of order unit and inventory amount are information existing at suppliers that receive a part order as received-order information.

When the client terminal 1 displays information of part selected by a user on the part information display window 102 (see FIG. 7), the client terminal 1 can obtain information of order unit and inventory amount of the concerned part from the supplier server 4. Then, in addition to information included in the electronic catalog, the client terminal 1 may display information of order unit and inventory amount of the concerned part obtained from the supplier server 4 on the part information display window 102, by which a user can order a part by checking order unit and/or inventory amount, and thereby mistake or error of part order can be furthermore reduced.

Further, when the order unit is obtained, the client terminal 1 can set a limit for the input amount for the order unit in the order operation window 106, by which mistake or error of order unit can be furthermore effectively prevented.

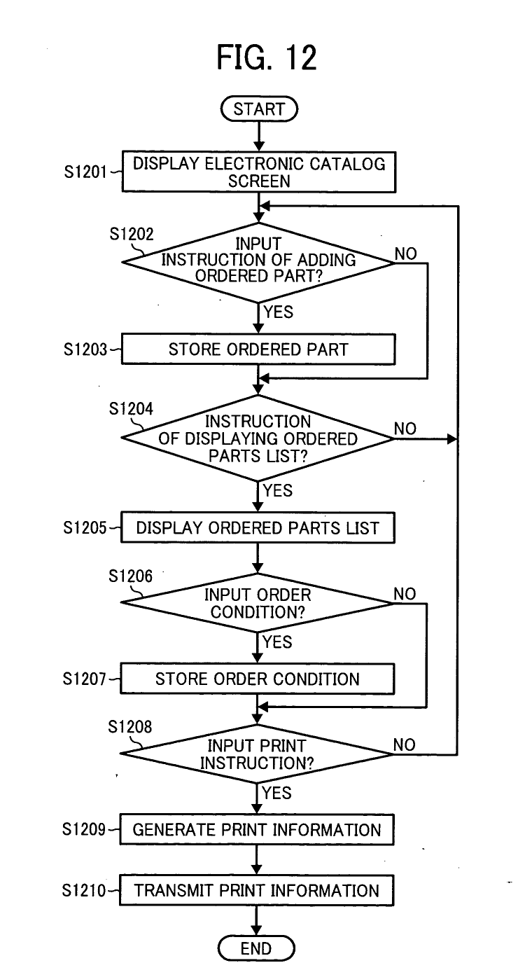

Further, as shown in FIG. 9, the order information may be generated based on a search result for electronic catalog, and then transmitted to the supplier server 4 via a network. Furthermore, based on the order information, image data of order sheet can be generated, and output as a paper form, which is described with reference to FIG. 12. FIG. 12 shows a flowchart of generating an image of an order sheet based on the order information and outputting the order sheet as a paper form. Steps S1201 to S1207 of FIG. 12 are similar to steps S901 to S907 of FIG. 9.

In case of FIG. 12, an “order sheet printing” button for instructing a printing of order sheet may be displayed on the ordered parts list of FIG. 8 instead of the order button. When the “order sheet printing” button is clicked (step S1208: YES), the client terminal 1 generates print information for printing an order sheet based on the ordered part and order condition stored in the client, terminal 1 (step S1209), and transmits the print information to an image forming apparatus such as a printer (step S1210). The image forming apparatus that receives the print information prints out the order sheet such as an order bill.

In case of FIG. 12, the printout of order sheet may be transmitted from an order entity to a supplier by a facsimile or the like, by which an ordering process ends. Even in such case, the parts management is conducted consistently using parts code of set by suppliers from generation of electronic catalog, searching of parts for electronic catalog, to transmission of order information, and the printed order sheet includes parts code of suppliers. In such system, human mistake or error such as inputting wrong parts code for part that needs procurement can be prevented. Further, because the order information is generated based on the search result for electronic catalog, a workload for ordering entity can be reduced. Further, when a plurality of parts is ordered as the ordered part to different order receiving entities such as suppliers, the order sheet is generated and printed for each of order receiving entities such as suppliers separately.

Further, as shown in FIG. 5A, the parts code may be set as attribution information for each part in the machine design information. The catalog generator 3 compares the parts code in the machine configuration information, and the parts code set as attribution information in the machine design information to determine a correspondence relationship between the machine configuration information and image of part.

The machine design information may be provided, for example, by suppliers that supply parts. Depending on format of design information at each of suppliers (hereinafter, design identification information), identification information of part included in the design identification information, and identification information used for receiving of part order (hereinafter, order-receiving identification information) may be different.

In such a situation, the catalog generator 3 refers to a table describing the corresponding relationship between the design identification information and the order-receiving identification information when generating a catalog, in which the parts code for image in the design identification information is corresponded to the parts code in the order-receiving identification information. With such a configuration, the above described effective and efficient parts management system can be similarly devised.

Further, in the above described example embodiment, the catalog generator 3 generates an electronic catalog based on the machine configuration information, in which parts included in the machine configuration information may be included in the electronic catalog, in general. However, some parts configuring a machine may not need replacement or cannot be replaced. Preferably, such parts may not be included in the electronic catalog.

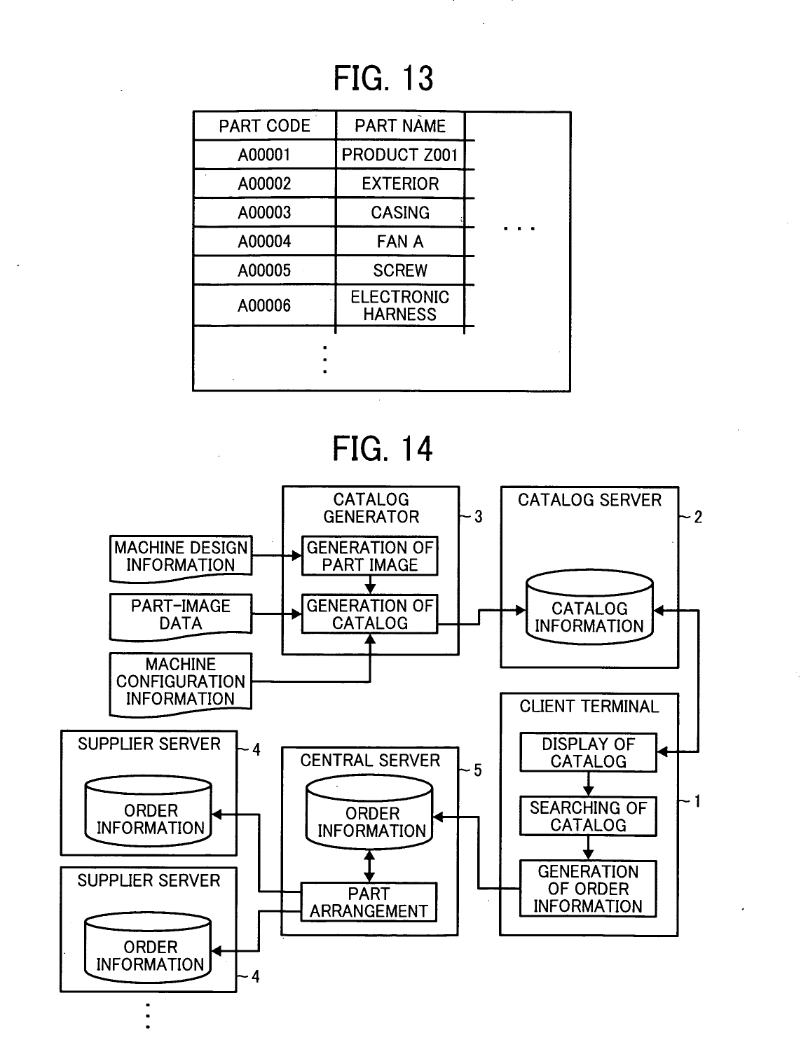

In such a case, a user or operator may prepare information of a parts list (hereinafter, parts classification information), shown in FIG. 13, to be included in an electronic catalog in addition to the three types of information shown in FIG. 3, and inputs the parts classification information to the catalog generator 3. The parts classification information classifies which part is required to be included in the electronic catalog. FIG. 13 shows the parts classification information, which is prepared as inclusive-part information that lists parts required to be included in the electronic catalog. With such a configuration, the catalog generator 3 can generate an electronic catalog only for parts having parts codes included in the inclusive-part information even though the machine configuration information may include other parts not listed in the inclusive-part information. Further, parts in the machine configuration information and parts in the inclusive-part information can be matched easily by comparing parts codes. With such a configuration, catalog information including only parts that need to be described in a catalog can be generated.

As such, the inclusive-part information may be a parts list including information of parts that need to be included in an electronic catalog.

Furthermore, instead of the inclusive-part information, the parts classification information may be prepared as exclusive-part information. The exclusive-part information may be a parts list including information on parts that do not need to be included in an electronic catalog. With such a configuration, similar to using the inclusive-part information, catalog information including only parts that need to be included in an electronic catalog can be generated, in which the catalog generator 3 can generate an electronic catalog by excluding parts having parts codes included in the exclusive-part information.

Further, the order receiving entities for each part may be managed by the parts management system using information shown in FIG. 4, and when the client terminal 1 generates and transmits order information, the order information is transmitted to the supplier server 4 for each of order receiving entities separately, in which the client terminal 1 is connected to a plurality of order receiving entities. However, if a single supplier supplies parts for one machine, the client terminal 1 may be connected to one order receiving entity.

Furthermore, as another embodiment of parts ordering system for machines, a parts center may be disposed for the parts management system, in which parts supplied by various suppliers may be received and managed as inventory at the parts center, and then the parts center receives orders from each client. Such configuration is described with reference to FIG. 14, which shows an overall configuration of parts management system using the parts center.

In FIG. 14, the order information generated by the client terminal 1 is transmitted to a central server 5 disposed at the parts center. The central server 5 stores the order information received from the client terminal 1. With such a configuration, an operator of the central server 5 can confirm receiving of part order, and then inventory check of part and delivery of part may be conducted at the parts center. In case of FIG. 3, the parts supplier to the client is a supplier, but in case of FIG. 14, the parts supplier to the client is the parts center.

In the above described parts management system shown in FIG. 3, the parts management is conducted consistently using parts code set by suppliers, which is used by the suppliers to manage parts, and the client terminal 1 orders parts using such parts code used at the suppliers.

In case of FIG. 14, the parts code used in the parts management system may be parts code used in the central server 5 of parts center for managing parts. As similar to a configuration shown in FIG. 3, human mistake or error such as inputting wrong parts code for part that needs procurement can be also prevented in a configuration show in FIG. 14.

As described above, the parts center itself is not an original supplier of parts but an intermediary entity between the original suppliers and clients, in which the parts center receives parts from the original suppliers and manages as the inventory. When the inventory becomes short, the parts center needs to order parts to suppliers to secure the inventory. However, as described above, the parts code used in the parts management system of FIG. 14 may be parts code used by the parts center to manage parts, and thereby such parts code of the parts center may not be identical to parts code used by suppliers that supply parts.

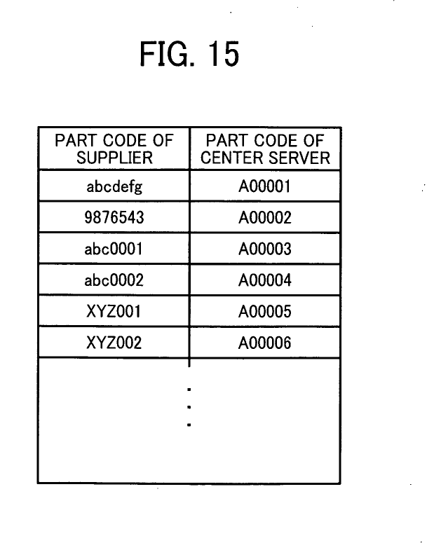

In such a case, as shown in FIG. 15, the central server 5 may retain a table including parts codes of suppliers and parts codes of the parts center, associated each other for the same part. Based on the table, the central server 5 converts the parts codes of parts and orders the parts to suppliers, and thereby the central server 5 can preferably order parts, which is short of inventory, to suppliers. Further, in addition to the associated information of parts codes used by suppliers and parts codes at central server, the table of FIG. 15 may include information of order receiving entities such as suppliers for supplying parts, by which order receiving entities for supplying parts can be determined easily.

Further, the above described flowchart processes shown in each drawing can be prepared as a computer-readable program, which can be executed by a CPU of information processing apparatus. Such a program can be stored in a storage medium such as a semiconductor storage, an optical storage, a magnetic storage, or the like. Further, such a program and storage medium can be used in system, which may be different from the above-described example embodiments, and by executing the program using a CPU of system, an effect similar to the above-described example embodiment can be devised. As such, in the above-described exemplary embodiment, a computer can be used with a computer-readable program to control functional units used for a parts management system or apparatus. For example, a particular computer may control the parts management system or apparatus using a computer-readable program, which can execute the above-described processes or steps. Further, in the above-described exemplary embodiment, a storage device (or recording medium), which can store computer-readable program, may be a flexible disk, a compact disk read only memory (CD-ROM), digital versatile disk (DVD), a memory card, a memory chip, or the like, but not limited these. Further, a computer-readable program can be downloaded to a particular computer (e.g., personal computer) via a network, or a computer-readable program can be installed to a particular computer from the above-mentioned storage device, by which the particular computer may be used for the parts management system or apparatus according to example embodiments, for example.

As described above, when ordering parts configuring a machine, order-mistake of parts can be prevented and a workload for ordering entity can be reduced.

The above described parts management apparatus includes a catalog data generator to generate catalog data for display of a parts catalog based on image data of a part configuring a machine, and machine configuration information describing a configuration of the machine using identification information for the part configuring the machine, the generated catalog data stored in a catalog data storage unit; a display data generator to generate display data displayable on an interface based on the stored catalog data, the display data including the parts catalog and an operating unit for placing an order for the part; and an order information generator to generate order information including the identification information of the part, a quantity of the part, and a delivery destination for the part, in response to inputting an order for the part to the interface.

As for the above described parts management apparatus, the order information generator generates order information further including image data of the part.

The above described parts management apparatus further includes an image data generator to generate image data of the part based on machine design information including shape information of the part indicating a three-dimensional shape of the part.

As for the above described parts management apparatus, the shape information of the part included in the machine design information is associated with the identification information of the part, and the image data generator generates the image data of the part using the shape information of the part associated with the identification information of the part.

As for the above described parts management apparatus, when a plurality of same parts is used in a machine, each of the same parts has a same identification information for identifying the part and also has specific-position information for identifying a position of the each of the same parts, the position of the each of the same parts being different each other, and the image data generator generates the image data of each of the same parts by associating the identification information of the same parts, the shape information of the same part, and the specific-position information different for each of the same parts.

As for the above described parts management apparatus, the catalog data generator generates the catalog data by associating information on the part and information on an order receiving entity that receives an order for the part, and the order information generator generates the order information by associating the information on the order receiving entity with the part identified by the identification information, and the parts management apparatus further includes an order information transmitting unit to transmit the generated order information to the order receiving entity based on the information on the order receiving entity associated with the generated order information.

The above described parts management apparatus is connected to a received-order information storage unit to store information on an order for the part received by a part supplier supplying the part, and the display data generator obtains information on the part, received as an order by the part supplier, from the received-order information storage unit, and displays the information on the part in the parts catalog.

As for the above described parts management apparatus, the identification information is information used by a part supplier for managing the part.

As for the above described parts management apparatus, the catalog data generator determines a part to be included in the parts catalog based on parts classification information, and generates the catalog data for the part to be included in the parts catalog, wherein the parts classification information is any one of inclusive part information and exclusive part information.

As for the above described parts management apparatus, the display data generator obtains the catalog data from the catalog data storage unit via a network.

The above described parts management method includes, the steps of obtaining catalog data for display of a parts catalog, using an information processing apparatus, based on image data of a part configuring a machine and machine configuration information describing a configuration of the machine using identification information for the part configuring the machine; storing the generated catalog data in a catalog data storage unit; generating display data displayable on an interface at the information processing apparatus based on the stored catalog data, the display data including the parts catalog and an operating unit for inputting an order for the part; and generating order information including identification information for the part, a quantity of the part, and a delivery destination for the part, in response to inputting an order for the part to the interface.

As for the above described parts management method, the order information is generated by further including image data of the part.

As for the above described parts management method, image data of the part is generated based on machine design information including shape information of the part indicating a three-dimensional shape of the part.

As for the above described parts management method, the shape information of the part included in the machine design information is associated with the identification information of the part, and the image data of the part is generated using the shape information of the part associated with the identification information of the part.

As for the above described parts management method, when a plurality of same parts is used in a machine, each of the same parts has a same identification information for identifying the part and also has specific-position information for identifying a position of the each of the same parts, the position of the each of the same parts being different each other, and the image data of each of the same parts is generated by associating the identification information of the same parts, the shape information of the same part, and the specific-position information different for each of the same parts.

As for the above described parts management method, the catalog data is generated by associating information on the part and information on an order receiving entity that receives an order for the part. The order information is generated by associating the information on the order receiving entity with the part identified by the identification information. The parts management method further includes the steps of transmitting the generated order information to the order receiving entity based on the information on the order receiving entity associated with the generated order information.

As for the above described parts management method, the parts management method further includes the steps of storing information on an order for the part received by a part supplier supplying the part in a received-order information storage unit. The display data generating step obtains information on the part, received as an order by the part supplier, from the received-order information storage unit, and displays the information on the part in the parts catalog.

As for the above described parts management method, the identification information is information used by a part supplier for managing the part.

As for the above described parts management method, a part to be included in the parts catalog is determined based on parts classification information, and the catalog data for the part to be included in the parts catalog is generated, wherein the parts classification information is any one of inclusive part information and exclusive part information.

As for the above described parts management method, the display data generating step obtains the catalog data from a catalog data storage unit via a network.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. A parts management system, comprising:
a catalog data generator to generate catalog data for display of a parts catalog based on image data of a part configuring a machine, and machine configuration information describing a configuration of the machine using identification information for the part configuring the machine;
a catalog data storage unit to store the generated catalog data;
a display data generator to generate display data displayable on an interface based on the stored catalog data, the display data including the parts catalog and an operating unit for placing an order for the part; and
an order information generator to generate order information including the identification information for the part, a quantity of the part, and a delivery destination for the part, in response to inputting an order for the part via the interface.

2. The parts management system of claim 1, wherein the order information generator generates order information further including image data of the part.

3. The parts management system of claim 2, further comprising an image data generator to generate image data of the part based on machine design information including shape information of the part indicating a three-dimensional shape of the part.

4. The parts management system of claim 3, wherein the shape information of the part included in the machine design information is associated with the identification information of the part, and the image data generator generates the image data of the part using the shape information of the part associated with the identification information of the part.

5. The parts management system of claim 3, wherein when a plurality of same parts is used in a machine, each of the same parts has a same identification information for identifying the part and also has specific-position information for identifying a position of the each of the same parts, the position of the each of the same parts being different each other, and
the image data generator generates the image data of each of the same parts by associating the identification information of the same parts, the shape information of the same part, and the specific-position information different for each of the same parts.

6. The parts management system of claim 3, wherein the catalog data generator generates the catalog data by associating information on the part and information on an order receiving entity that receives an order for the part,
the order information generator generates the order information by associating the information on the order receiving entity with the part identified by the identification information,
the parts management system further comprising an order information transmitting unit to transmit the generated order information to the order receiving entity based on the information on the order receiving entity associated with the generated order information.

7. The parts management system of claim 6, further comprising a received-order information storage unit to store information on an order for the part received by a part supplier supplying the part,
wherein the display data generator obtains information on the part, received as an order by the part supplier, from the received-order information storage unit, and displays the information on the part in the parts catalog.

8. The parts management system of claim 1, wherein the identification information is information used by a part supplier for managing the part.

9. The parts management system of claim 1 wherein the catalog data generator determines a part to be included in the parts catalog based on parts classification information, and generates the catalog data for the part to be included in the parts catalog, wherein the parts classification information is any one of inclusive part information and exclusive part information.

10. The parts management system of claim 1, wherein the display data generator obtains the catalog data from the catalog data storage unit via a network.

11. A parts management apparatus, comprising:
a catalog data generator to generate catalog data for display of a parts catalog based on image data of a part configuring a machine, and machine configuration information describing a configuration of the machine using identification information for the part configuring the machine, the generated catalog data stored in a catalog data storage unit;
a display data generator to generate display data displayable on an interface based on the stored catalog data, the display data including the parts catalog and an operating unit for placing an order for the part; and
an order information generator to generate order information including the identification information of the part, a quantity of the part, and a delivery destination for the part, in response to inputting an order for the part to the interface.

12. A parts management method, comprising the steps of:
obtaining catalog data for display of a parts catalog, using an information processing apparatus, based on image data of a part configuring a machine and machine configuration information describing a configuration of the machine using identification information for the part configuring the machine;
storing the generated catalog data in a catalog data storage unit;
generating display data displayable on an interface at the information processing apparatus based on the stored catalog data, the display data including the parts catalog and an operating unit for inputting an order for the part; and
generating order information including identification information for the part, a quantity of the part, and a delivery destination for the part, in response to inputting an order for the part to the interface.
